(19) United States
(12) Patent Application Publication
(10) Pub. No.: US 2025/0263271 A1
(43) Pub. Date: Aug. 21, 2025

(54) METHOD FOR MEASURING THE BRAKING DISTANCE OF AN ESCALATOR OR A MOVING WALKWAY

(71) Applicant: Inventio AG, Hergiswil (CH)

(72) Inventors: Wolfgang Neszmerak, Wien (AT); Christoph Makovec, Wiener Neustadt (AT); Gerhard Kleewein, Pressbaum (AT)

(21) Appl. No.: 18/855,188

(22) PCT Filed: May 2, 2023
(86) PCT No.: PCT/EP2023/061520

§ 371 Date: Oct. 8, 2024

(30) Foreign Application Priority Data
May 24, 2022 (EP) 22174998.9

(51) Int. Cl. B66B 27/00

(52) U.S. Cl. CPC B66B 27/00

(57) ABSTRACT

The invention relates to a method for measuring the braking distance and to a braking distance measuring device for carrying out the method on an escalator or a moving walkway. The braking distance measuring device has at least one trigger device which can be connected to the controller of the escalator or the moving walkway, an optically detectable linear measuring scale, an optical sensor, and an acoustic sensor. In order to allow a more precise measurement of the braking distance, a braking process is optically and acoustically recorded as an image sequence with a graphically displayed audio track. The start point and the end position of braking operation noises recorded on the audio track can be precisely assigned to the images of the image sequence, and the braking distance is ascertained from the determined images by comparing the different positions of a marking with the measuring scale.

### TECHNICAL FIELD

The present disclosure relates to a method for measuring the braking distance of an escalator or a moving walkway, to a braking distance measuring device for carrying out this method, and to an escalator or a moving walkway having such a braking distance measuring device.

### SUMMARY

Escalators and moving walkways serve to transport people and are used in department stores, shopping malls, train stations, airports, and the like. For this purpose, they have a conveyor belt which is arranged in the escalator or moving walkway such as to move in a circular manner and which can be driven by a drive motor. Since these systems are used to transport people, they are subject to high safety requirements, such as those defined in the European Standard EN115-1 or US Standard ASME A17.1/CSA B44.

One of these safety regulations relates to the permissible length of the braking distance of the conveyor belt. The braking distance inevitably occurs as a result of the inertia of the moving parts after the drive motor is disconnected from the power supply and a service brake or safety brake (hereinafter referred to as unspecified brake) of the escalator or moving walkway is activated. Most authorities require the operators or companies entrusted with the maintenance of these systems to periodically check the length of the braking distance and to service the brake if braking does not comply with the applicable standard values. To prevent users from falling, the brake may not engage too much. That is why the standards also specify a maximum permissible deceleration when braking. For example, EN115-1 for escalators and moving walkways specifies a standard braking distance of the conveyor belt in the range between 0.4 m and 1.5 m at a given nominal speed of 0.75 m/s (operating speed), wherein the maximum permissible deceleration of 1 m/s² must not be exceeded.

In order to measure the standard braking distance of the conveyor belt, JP2008265971A proposes a braking distance measuring device and a method for carrying out this measurement. A linear measuring scale is attached to the conveyor belt and an optical sensor is temporarily attached to a fixed part of the escalator or moving walkway and connected to the escalator's controller. The conveyor belt is then brought up to operating speed. As soon as the optical sensor detects the leading end of the measuring scale, a stop signal is sent to the controller and the conveyor belt is slowed down by the brake. The distance covered by the optical sensor on the measuring scale corresponds to the standard braking distance. This measuring method therefore complies exactly with the EN115-1 standard specifications, which stipulate that the braking distance must be measured from the occurrence of the stop signal until the conveyor belt comes to a standstill. Furthermore, the standard recommends keeping the standard braking distance as close to the lower limit of the range as possible (0.4 m in the example).

The braking distance measuring method described above has the disadvantage that periods of time without braking torque are also recorded, such as the response times of the optical sensor, the controller and the electromechanical switches (contactor or relay) to be controlled by the controller, as well as the response time of the brake from the separation of the ventilation current to the braking torque starting to take effect. The braking distance measuring method described therefore does not provide any measurement results that reflect the actual braking behavior of the brake (braking distance while the braking torque of the brake is acting).

The object of the present disclosure is to provide a braking distance measuring method which provides more precise measurement results regarding the actual braking behavior of the brake.

This object can be achieved by the methods for measuring the braking distance of an escalator or moving walkway described herein as well as by a braking distance measuring device for carrying out this method.

The escalator or moving walkway on which such a measurement can be carried out can have a conveyor belt, at least one drive motor for driving the conveyor belt, a brake for braking the conveyor belt and a controller. The drive motor and the brake can be controlled by the controller. The method for measuring the braking distance can be used for all known types of brakes on escalators and moving walkways. To carry out the method, a braking distance measuring device can be arranged in the region of the conveyor belt, which can comprise at least one trigger device which can be connected to the controller, an optically detectable linear measuring scale and an optical sensor.

The method for measuring the braking distance can comprise several steps that can be carried out in the order described herein. However, this order is not mandatory: where appropriate, method steps can be carried out before or after other method steps, or further method steps, as described herein, can be carried out between these method steps.

In one method step, the linear measuring scale can be arranged in the escalator or moving walkway such that it has a course of movement relative to a marking as a result of a movement of the conveyor belt. This relative course of movement can be recorded by the optical sensor, for example as an image sequence. As explained herein, there can be different ways to arrange a measurement scale and define or arrange a marking.

In a further method step, the conveyor belt can be brought to a specified speed. The specified speed can correspond to the transport speed during normal operation, which can be referred to as the nominal speed. The specified speed can also be faster or slower than the nominal speed if different operating conditions of the service brake are to be tested. Once the specified speed is reached, a stop signal is sent to the controller using the trigger device. The stop signal can be triggered manually, for example, by a manual input into the trigger device. However, it is also possible to generate the stop signal automatically through the trigger device, for example, in that reaching the specified speed can trigger the stop signal in the trigger device.

In a further method step, the optical sensor can be used to record the relative course of movement at least from the stop signal until the conveyor belt comes to a complete standstill. In addition, the braking distance measuring device can comprise an acoustic sensor that records the braking operation noises of the brake in synchronization with the optical recording. These braking operation noises can reflect the actual braking operation in chronological order. Since the relative course of movement was recorded synchronously, the beginning of the braking operation noises can be clearly assigned to a specific image of the relative course of movement recorded as an image sequence. To determine the braking distance, a subsequent image from the captured image sequence of the motion sequence may be selected, which was clearly captured at a time when there were no more braking operation noises present. Now, if the two images are compared, the braking distance covered during the actual use of the brake can be read from the different positions of the marking relative to the measuring scale.

The braking distance measured in this way can make it possible, for example, to calculate the average deceleration of the brake more precisely. It is also possible to record a braking curve (distance/time diagram, wherein time is defined by the number of images per second) by evaluating the braking distance traveled step by step from image to image, from which the maximum deceleration can be read. Based on these measurement results, the brake can be adjusted close to the maximum permissible deceleration. This can minimize the actual braking distance without exceeding the given maximum deceleration value.

Measuring the braking distance during actual use of the brake can also have advantages as regards to diagnosing the technical condition of the escalator or moving walkway. For example, the condition of the brake pads and/or their changes compared to previous measurements can be assessed more precisely. Furthermore, the time at which the stop signal is triggered can also be recorded, which can allow an image from the recorded image sequence to be assigned to it. If optical capturing of the motion sequence begins with the stop signal, it is logically the first image. The response time of the braking system until the brake actually applies a braking torque and the distance covered in the process can now be determined by comparing the two recording times of this first image and the image with the beginning of the braking operation noises. Also, the distance traveled by the marking, hereinafter referred to as reaction length, can be determined using these two images. A response time or reaction length that is too long compared to empiric values can indicate that, for example, the contactors mentioned above need to be replaced. As mentioned at the beginning, the EN115-1 standard stipulates that the braking distance must be recorded from the moment the stop signal occurs until the conveyor belt comes to a complete standstill. This standard braking distance can be determined by simply adding the reaction length and braking distance.

As described herein, this evaluation work can be done entirely manually, but this is time-consuming. In a further development of the method, the recording of the relative movement and the recording of the braking operation noises recorded synchronously therewith can therefore be shown as a graphically displayed audio track parallel to each other in an image sequence. This may make it much easier to determine the two or three relevant images of an image sequence described above, since the images do not first have to be assigned based on the cycle of the braking operation noises by reading out the recording times.

A start position of the marking relative to the measuring scale can now be extracted from the image sequence using a start point of the braking operation noise. Furthermore, an end position of the marking relative to the measuring scale can also be extracted from the elimination of the braking operation noise. The image containing the end position can also be defined with a fixed final position at which braking operation noises may be guaranteed to no longer occur, since once the conveyor belt has stopped, braking operation noises may no longer be present and all subsequently recorded images in the image sequence may look exactly the same.

In a further development of the present disclosure, the determination of the start position and the final position from the graphically displayed braking operation noise or audio track can be carried out automatically with an image processing program. The image processing program can use well-known image analysis methods and image analysis algorithms, which are known from the electronic processing of video sequences. These analysis algorithms can be based, for example, on known image processing techniques that are optimized and applied in self-learning processes using artificial intelligence in neural networks. A common image processing technique for generating information from an image is, for example, the calculation of the histogram which provides information about the statistical brightness distribution in the image. Such a histogram can serve, for example, as a configuration for further image processing steps or as information for a human user of software. Other computable information about an image is, for example, its entropy or average brightness. Based upon this information, vector analyses can follow how individual prominent points move relative to one another, and conclusions can be drawn from this about motion scenarios of the marking relative to the measuring scale. With the aforementioned methods, for example, an image analysis of the audio track optically displayed in the image sequence can be carried out and the image of the image sequence containing the start point of the braking operation noise and one of the images of the image sequence in which the elimination of the braking operation noise can be clearly identified can be marked in the image sequence. Of course, an analysis of the noise level of the recorded braking operation noise can also be carried out so that the time of the start and end of braking operation can be determined and the corresponding images from the image sequence can be identified via the temporal assignment.

In a further automation step of the present method, the distance between the start position and the end position can be determined by comparing the two marked images of the image sequence. This distance can correspond to the braking distance covered during the braking operation of the brake. The different positions of the marking in relation to the measuring scale can be read out, for example, by optical character recognition (OCR) of numbers applied to the measuring scale and subsequent calculation of the difference.

In one embodiment of the present disclosure, the trigger device can be connected to the controller. The trigger device can retrieve operating data of the drive motor from the controller, wherein a stop signal can be sent to the controller as soon as the drive motor has reached a speed that corresponds to the specified speed of the conveyor belt.

In a further embodiment of the present disclosure, the stop signal can be entered manually into the trigger device, for example, by pressing a push button or via a keyboard of the trigger device. As soon as the stop signal is entered, it may be transmitted directly from the trigger device to the controller. Further commands can be transmitted to the controller via the keyboard, which can also be generated on a touch-sensitive screen of the trigger device. For example, the start command can be entered via the keyboard so that the controller can set the conveyor belt in motion. Furthermore, the conveying direction or the direction of movement of the conveyor belt can also be entered via the keyboard. It is also possible for the controller to transmit operating data of the passenger conveyor system, such as the current speed, to the trigger device, which can then be displayed on the screen. The controller can also transmit safety-relevant messages to the trigger device so that, for example, a refusal of the start command and the underlying cause can be displayed on its screen.

In summary, the braking distance measuring device for carrying out the method described above can have at least one trigger device that can be connected to the controller, an optically detectable linear measuring scale, an optical sensor, and an acoustic sensor. The optical sensor, the acoustic sensor and the trigger device can preferably be part of a smartphone or tablet with a software application (computer program). The software application can comprise at least program steps which enable a synchronous recording of a movement of the arranged or defined marking relative to the measuring scale and of the braking operation noises. The software application can also contain program parts with which the image processing described herein can be carried out. Furthermore, a wired or wireless connection to the controller of an escalator or moving walkway can be created temporarily.

Preferably, the braking distance measuring device can comprise a holder for the smartphone or tablet, wherein this holder can be temporarily arranged on a fixed part of an escalator or moving walkway. This fixed part can be, for example, a balustrade or a balustrade base or a floor covering of the escalator or moving walkway.

In order to ensure that the braking operation noises can be recorded with good quality, at least the linear measuring scale, the optical sensor and the acoustic sensor of the braking distance measuring device can preferably be arranged in a drive region of the escalator or moving walkway. In case of an escalator, the drive region can be formed in the upper access region so that the conveyor belt is mainly subjected to tensile forces. In the drive region, the drive motor, a drive shaft, a gear and the brake can be arranged beneath a walkable floor covering. The escalator's conveyor belt can be accessed or left via this walkable floor covering. Moving walkways can be generically designed in a similar way.

As already mentioned herein, there are various options for arranging the linear measuring scale and, if applicable, the marking. The linear measuring scale can preferably have a slat-shaped support with a metric length scale and/or a length scale in inches. The marking can be an existing contour of the escalator or moving walkway, but it can also be a temporarily attachable object such as a sticker, a colored dot, etc.

In a first embodiment, the marking can be arranged or defined on the conveyor belt and the linear measuring scale can be arranged on a fixed part of the escalator or moving walkway. In order to simplify handling for the person entrusted with the measurement, the marking can preferably be defined. Here, the marking can be, for example, a gap between two escalator steps of the escalator's conveyor belt or a gap between two pallets of the moving walkway's conveyor belt. Of course, a marking that can be temporarily applied to the conveyor belt can also be used, such as a line drawn with a waterproof felt-tip pen that extends transversely to the direction of movement of the conveyor belt.

In a second embodiment, the measuring scale can be arranged on the conveyor belt and the marking can be defined or arranged on a fixed part of the escalator or moving walkway. A marking can be defined, for example, as a sheet metal joint between two cladding sheets of a balustrade of the escalator or moving walkway. Of course, it is also possible to use a marking that can be temporarily attached to the balustrade, for example, an arrow-shaped sticker.

### BRIEF DESCRIPTION OF THE DRAWINGS

Embodiments of the disclosure will be described below with reference to the accompanying drawings, wherein neither the drawings nor the description are intended to be interpreted as limiting the disclosure. The figures are merely schematic and not true to scale. Identical or equivalent features have the same reference signs. In the drawings:

FIG. 1 shows a schematic sectional side view of an escalator and its most important components;

FIG. 2 shows a three-dimensional partial view of the drive region shown in FIG. 1 with a braking distance measuring device;

FIG. 3 shows a three-dimensional view of a smartphone with a software application due to which the smartphone can be used as a component of the braking distance measuring device;

FIG. 4 shows an image from an image sequence recorded by an optical sensor of the braking distance measuring device shown in FIG. 2;

FIG. 5A shows a first image from an image sequence recorded by the braking distance measuring device shown in FIG. 2 at the time of input of a stop signal;

FIG. 5B shows a second image from the same image sequence at the time of a start point at which braking operation noises recorded at the same time begin; and

FIG. 5C shows a third image from the same image sequence at the time of an end position at which braking operation noises recorded at the same time end.

### DETAILED DESCRIPTION

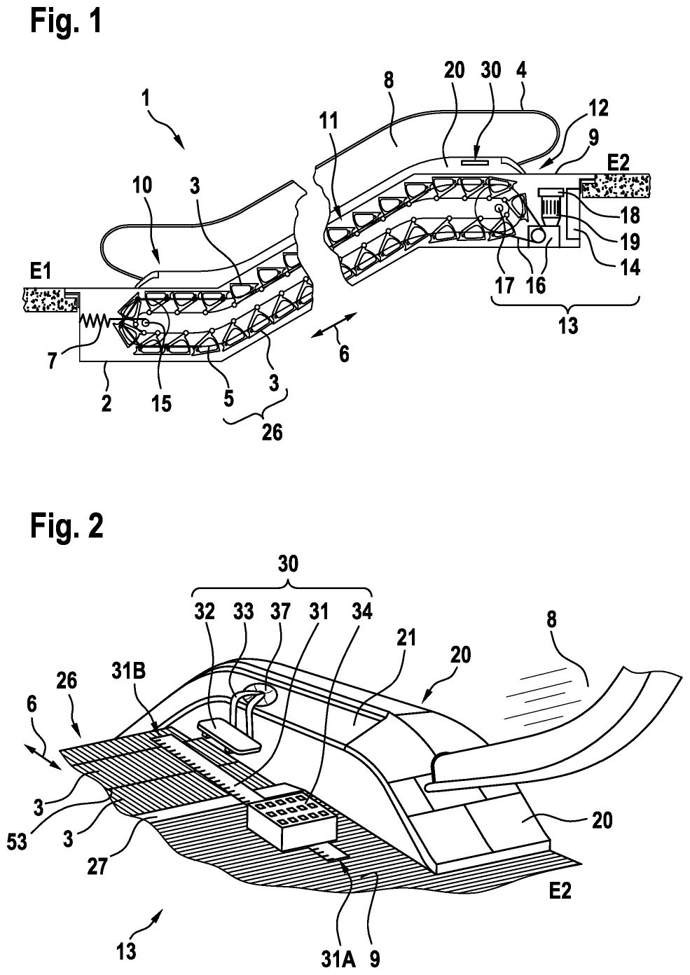

FIG. 1 shows a schematic sectional side view of an escalator 1 and its most important components. The escalator 1 serves to transport people, for example, between two levels E1, E2 of a building.

The escalator 1 has a conveyor belt 26 with several escalator steps 3 which are arranged one behind the other and which can be displaced in a direction of movement 6 along a travel path with the aid of two conveyor chains 5 (only one is visible in FIG. 1) which are closed in a ring shape and arranged parallel to one another. The double arrow of the direction of movement 6 indicates that the escalator 1 can transport users both from level E1 to level E2 and in the opposite direction. Each escalator step 3 is attached between the two conveyor chains 5 to the latter. In order to be able to move the conveyor chains 5, the escalator 1 has a drive region 13 in which a drive shaft 17, a gear 16, a drive motor 19 and a brake 18 are arranged. The escalator 1 can have different types of brakes, for example the service brake shown in FIG. 1, which is usually designed as a shoe brake or band brake. In addition, the escalator can also have a safety brake as disclosed, for example, in WO2014/009227A1.

The drive region 13 is usually arranged in the upper level E2 of the building, while a tensioning station 7 with a deflection axle 15, shown only schematically, is arranged in the lower level E1. The drive shaft 17 and deflection axle 15 and other load-bearing components of the escalator 1 are held in a supporting structure 2, usually in the form of a lattice structure, which for reasons of clarity is only sketched in FIG. 1. The escalator 1 also has two balustrades 8 (only one visible), each of which has a handrail 4 arranged all around it.

During an upwards movement direction 6, the escalator steps 3 are moved in a forward movement from a lower access region 10 of the escalator 1 adjacent to the lower level E1, via a central inclined region 11, to an upper access region 12 adjacent to the upper level E1, and are then moved back in the opposite direction in a return movement.

The drive motor 19 and the brake 18 arranged in the drive region 13 are controlled and regulated with a controller 14. The torque or the rotary movement of the motor shaft (concealed by the gear) of the drive motor 19 is transmitted to the drive shaft 17 via the gear 16 (a worm gear and a drive chain are shown as an example). Since there are usually two conveyor chains 5 between which the escalator steps 3 are arranged, the drive shaft 17 may also comprise two drive sprockets (not shown in detail) via which the conveyor belt 26 is guided in a manner such as to transmit motions. All components of the drive region 13 are also accommodated in the supporting structure 2 and are spanned by a walkable floor covering 9, which is part of the upper access region 12.

Furthermore, a braking distance measuring device 30 for measuring the braking distance is arranged in the drive region 13 of the escalator 1. In the present exemplary embodiment, this braking distance measuring device 30 can be installed temporarily, e.g., it can be installed, used and removed as required. However, a fixed installation of the braking distance measuring device 30 is also conceivable, for example, in a balustrade base 20 of the balustrade 8.

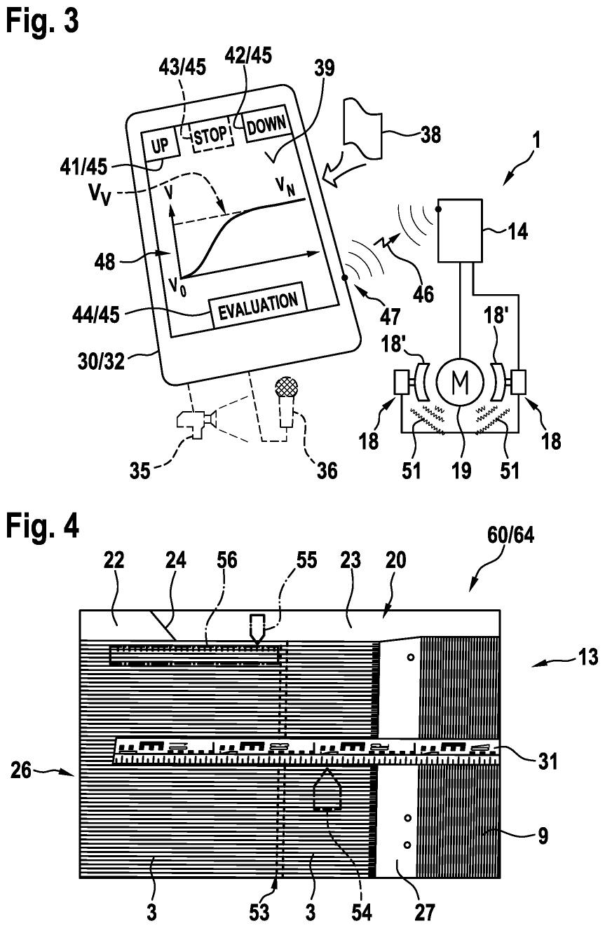

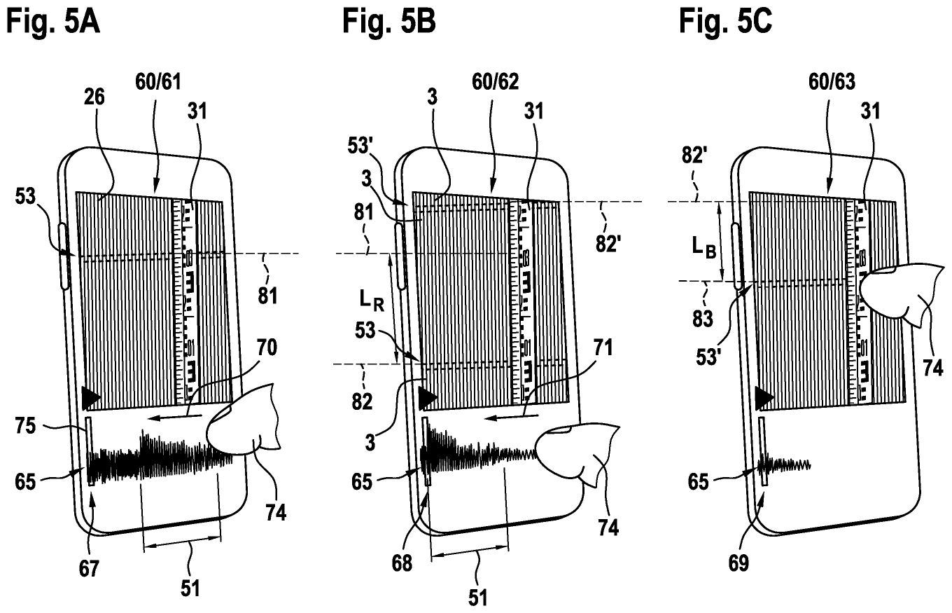

FIG. 2 shows a three-dimensional, enlarged partial view of the drive region 13 shown in FIG. 1 with a braking distance measuring device 30 installed. The braking distance measuring device 30 comprises a linear measuring scale 31 and a smartphone 32 with an optical sensor 35 and an acoustic sensor 36 (see FIG. 3). The braking distance measuring device 30 further comprises a holder 33 for the smartphone 32 and fastening means 34 for the linear measuring scale 31. In the present exemplary embodiment, the slat-shaped measuring scale 31 is placed with its first end 31A on the floor covering 9 and is fixed to the floor covering 9 in the form of a brick using the fastening means 34. The linear measuring scale 31 is arranged in the drive region 13 parallel to the direction of movement 6 with respect to its longitudinal extension. Its second end 31B protrudes beyond a comb plate 27 which can serve as a transition from the floor covering 9 to the conveyor belt 26 and also protrudes beyond more than two escalator steps 3 of the conveyor belt 26. In the present exemplary embodiment, the holder 33 has a suction cup 37 which is fixed to a cladding plate 21 of the balustrade base 20. The smartphone 32 rests on the holder 33, wherein the holder 33 is arranged on the cladding sheet 21 such that the optical sensor 35 of the smartphone 32 can detect both the linear measuring scale 31 and at least two escalator steps 3 of the conveyor belt 26. Since the brake 18 is located below the floor covering, this arrangement also ideally positions the acoustic sensor 36 (see FIG. 3) of the smartphone 32 for recording braking operation noises 51 (see FIGS. 5A to 5C).

FIG. 3 shows a three-dimensional view of a smartphone 32 with a software application 38 due to which the smartphone 32 can be used as a component of the braking distance measuring device 30. Moreover, the components drive motor 19, brake 18 and controller 14 of the escalator 1 are shown schematically in FIG. 3 in order to demonstrate their interactions with the smartphone 32.

Using a conventional smartphone 32 makes sense because it has sufficient computing capacity and storage capacity for storing and processing the software application 38 and because it comprises an optical sensor 35 (symbolically shown as a video camera), an acoustic sensor 36 (symbolically shown as a hand-held microphone) and a touch-sensitive screen 39 on which graphic buttons 41, 42, 43, 44 and thus manually operable elements of a trigger device 45 can be generated. The smartphone 32 furthermore has a communication module 47, with which a data connection to the controller 14 of the escalator can be established. Since a so-called tablet has the same components and features, it is also possible to use a tablet instead of the smartphone 32. Of course, generic components which are to be used instead of the smartphone 32 for the braking distance measuring device 30 can also be combined in a device specially designed and built for the braking distance measuring device 30. It is even possible to arrange the aforementioned components separately from one another in the drive region 13, wherein a communication connection 47 may be established at least temporarily between the trigger device 45, the optical sensor 35, the acoustic sensor 36 and, if applicable, the controller 14. The trigger device 45 can be designed as a hand-held device with a push button (not shown) in order to input a stop signal 46, for example.

The aforementioned software application 38 for the smartphone 32 can comprise at least program steps which can allow for synchronous recording of a movement of a marking 53, 54, 55 relative to the linear measuring scale 31 and of the braking operation noises 51 of the brake 18 (see FIG. 4). Further explanations regarding the linear measuring scale 31 and the mentioned markings 53, 54, 55 can be found herein, for example, in the description of FIG. 4.

The software application 38 moreover can comprise program steps with which the required graphic buttons 41, 42, 43, 44 and/or graphic representations 48 of operating data can be generated on the screen 39 following the process sequence. In the present exemplary embodiment, a first button 41 can serve to set the escalator 1 (see also FIG. 1) in motion with a direction of movement 6 from the lower floor E1 to the upper floor E2. With a second button 42, the escalator 1 can be set in motion with a direction of movement 6 from the upper floor E2 to the lower floor E1.

In a central region of the screen 39, a graphic representation 48 can be created and displayed with further program steps of the software application 38. The measurement data required for this purpose can be transmitted from the controller 14 via the communication module 47 to the smartphone 32 serving as the trigger device 45. The graphic representation 48 of the exemplary embodiment can show the acceleration behavior of the conveyor belt 26 from standstill V₀ to nominal speed V_{N}. As soon as the nominal speed V_{N} is reached, a stop signal 46 can be entered via a third button 43 of the trigger device 45 and sent to the controller 14 of the escalator 1. Inputting the stop signal 46 can, at the same time, activate the optical sensor 35 and the acoustic sensor 36 to record an image sequence 60 and an associated audio track 65 (see FIGS. 4 and 5A to 5C).

The stop signal 46 can be immediately processed by the controller 14 so that the drive motor 19 is disconnected from a power supply (not shown) and the brake 18 is activated by switching off a ventilation current. As soon as the brake shoes 18′ of the brake 18 engage, a loud braking operation noise 51 may be released with a decreasing tendency until the conveyor belt 26 (see FIG. 1) stops. At this point it should be noted that the braking operation noises 51 of a service brake and safety brake may differ, in particular, as the braking operation noise 51 subsides. What all brake types can have in common, however, is that the beginning of the braking operation noises 51 can be clearly recognized on the audio track 65. As soon as the conveyor belt 26 comes to a stop, an evaluation of the measurement results and a determination of a braking distance L_{B} from the measurement carried out can be initiated by tapping a fourth button 44 of the trigger device 45. The determination of the braking distance L_{B} is described herein with reference to FIGS. 5A to 5C.

FIG. 4 shows an image 64 from an image sequence 60 which was recorded by the optical sensor 35 of the braking distance measuring device 30 shown in FIGS. 1 and 2. The linear measuring scale 31 arranged above the escalator steps 3 of the conveyor belt 26 is clearly visible. Furthermore, the balustrade base 20 is partially visible, in particular two cladding sheets 22, 23 of the balustrade base 20 as well as the floor covering 9 and the comb plate 27.

As already mentioned above, the linear measuring scale 31 is arranged in the drive region 13 and a marking 53, 54 is defined or also arranged. In the actual arrangement captured in the image, a gap arranged between two escalator steps serves as a marking 53, which moves relative to the fixed measuring scale 31 when the conveyor belt 26 is running. In other words, the gap is defined as marking 53. Alternatively, a special marking 54 can be temporarily applied to the conveyor belt 26, for example, the arrow indicated by a broken line, which is preferably applied with a clearly visible color or as a sticker on one of the escalator steps 3. It should also be noted that with a conveyor belt 26 of a moving walkway, the gap between two pallets can be defined as a marking 53. Due to the very narrow design of pallets, it may be better to provide a temporarily attachable marking 54.

As shown by the dash-dotted line, the measuring scale 56 can also be arranged on the conveyor belt 26, for example, as a sticker. In this embodiment, the marking 24, 55 is to be provided on a fixed part of the escalator 1 or moving walkway. For example, a sheet metal joint between the two cladding sheets 22, 23 can be defined as marking 24. In this embodiment, the marking 55 can also be an arrow-shaped sticker which can be temporarily attached to a fixed part of the escalator 1 or moving walkway.

The method that can be carried out with the braking distance measuring device 30 described herein is explained herein with reference to FIGS. 5A to 5C and with the aid of FIGS. 2 and 3. FIG. 5A shows a first image 61 from an image sequence 60 recorded by the braking distance measuring device 30 at the time of input 67 of a stop signal 46. FIG. 5B shows a second image 62 from the same image sequence 60 at the time of a start point 68 at which braking operation noises 51 recorded at the same time begin. FIG. 5C shows a third image 63 from the same image sequence 60 at the time of an end position 69 at which the braking operation noise 51 recorded at the same time ends.

The method for measuring the braking distance L_{B} of an escalator 1 or moving walkway can comprise, on the one hand, preparation steps and, on the other hand, measurement and evaluation steps. The preparation steps can comprise arranging a braking distance measuring device 30 in the drive region 13 above the conveyor belt 26. Possible embodiments have already been described herein with reference to FIGS. 2 and 4. Furthermore, the trigger device 45 of the braking distance measuring device 30 can be connected to the controller 14 of the escalator 1 such as to transmit signals.

The measuring steps can comprise the method steps required to generate image sequences 60 and an associated audio track 65 with the braking operation noises 51. The conveyor belt 26 can thus be brought to a specified speed V_{V}, for example, the nominal speed V_{N}. by a manual input on the trigger device 45. Once the specified speed V_{V} is reached, a stop signal 46 can be sent to the controller 14 with the trigger device 45. It is also possible for the trigger device 45 to receive operating data of the drive motor 19 from the controller 14 and for a stop signal 46 to be automatically sent to the controller 14 as soon as the drive motor 19 has reached a speed that corresponds to the specified speed V_{V} of the conveyor belt 26.

Once the stop signal 46 is input, the optical sensor 35 may start to record the relative course of movement between the marking 53 and the linear measuring scale 31 at least from the stop signal 46 until the conveyor belt 26 comes to a standstill V₀. The audio track 65 with the braking operation noises 51 of the brake 18 can be recorded synchronously with the optical recording, namely by the acoustic sensor 36 of the braking distance measuring device 30.

As shown in FIGS. 5A to 5C, for simpler and clearer evaluation, the recording of the relative movement between the marking 53 and the linear measuring scale 31 and the recording of the audio track 65 recorded synchronously therewith can be combined parallel to one another in an image sequence 60.

The first recorded image 61 of the image sequence 60 can be assigned to the time of input 67 of the stop signal 46. The audio track 65 may not be just a horizontal line, but may comprise a noise level that reflects the normal operating noise of escalator 1 at nominal speed V_{N}. The signal input position 81 shown with a broken line at the time of the stop signal 46 can be read out on the first image 61 from the position of the marking 53 to the measuring scale 31 and noted.

If, in the present exemplary embodiment of FIGS. 5A to 5C, the audio track 65 is pushed with the finger 74 against the fixed mark 75 generated by the software application 38 (see FIG. 3) on the screen 39 according to the arrow 70, the subsequent images of the image sequence 60 can be displayed on the screen 39 in chronological order.

As can be seen in FIGS. 5A and 5B, the audio track 65 shows a sudden increase in the noise level, which then continuously decreases. This section of the audio track 65 can contain the braking operation noises 51. The second image 62 shows the position of the marking 53 relative to the linear measuring scale 31 at the time of a start point 68 at which the parallel recorded braking operation noises 51 begin. The second image 62 may be displayed when the sudden increase in the noise level coincides with the fixed mark 75. Again, the position of the marking 53 can be read from the measuring scale 31 and captured as the start position 82 of the braking operation noises 51. The distance covered by the marking 53 between the signal input position 81 and the start position 82 can be the reaction length L_{R}, which may result because the controller 14 and the components involved in a braking operation, such as contactors for interrupting the ventilation current (not shown) and the brake 18 itself, have a certain response time.

The third image 63 of the image sequence 60 shows the position of the marking 53 relative to the linear measuring scale 31 at the time of an end position 69, at which the parallel recorded braking operation noises 51 on the audio track 65 end and the conveyor belt 26 has thus come to a stop. The third image 63 can be displayed when the noise level of the audio track 65 has dropped to the lowest level. The audio track 65 may show a background noise. Since the conveyor belt 26 stands still from this point on, all subsequent images of the image sequence 60 may look exactly the same. Instead of exactly determining the end of the braking operation noise 51, it is preferable to select an image 63 which reliably reflects a static state of the conveyor belt 26. This is the case when two images, which are temporally apart, show an identical position of the marking 53 relative to the measuring scale 31 at the end of the image sequence 60. Again, the position of the marking 53 can be read from the measuring scale 31 and can be captured as the end position 83.

As shown in FIGS. 5B and 5C, the marking 53 defined in FIG. 5A can disappear when the audio track 65 is moved further with the finger 74 at the lower edge of the image, which is why in FIG. 5B the subsequent gap between two escalator steps 3 is alternatively defined as marking 53′. Accordingly, a new start position 82′ can be read out on the measuring scale 31 and recorded.

The distance covered by the marking 53′ between the start position 82′ and the end position 83 can be the actual braking distance L_{B} during braking of the brake 18. As mentioned herein, the EN115-1 standard stipulates that the braking distance be recorded from the input 67 or from the moment the stop signal 46 occurs until the conveyor belt 26 comes to a complete standstill. This standard braking distance can be determined by simply adding the reaction length L_{R} and braking distance L_{B}.

The manual evaluation of the image sequence 60 described herein can also be carried out automatically using an image processing program by carrying out an image analysis of the course of the recorded braking operation noises 51 optically displayed in the image sequence 60 and by marking in the image sequence 60 the image of the image sequence 60 containing the start point 68 of the braking operation noise 51 and one of the images of the image sequence 60 in which the disappearance of the braking operation noise 51 can be clearly recognized. In the automated process, the braking distance L_{B} between the start position 82 and the end position 83 can also determined by comparing the two marked images of the image sequence 60. The different positions of the marking 53 in relation to the measuring scale 31 can be read out and the braking distance L_{B} can be determined by calculating the difference.

Although escalators are shown in FIGS. 1 and 2, the braking distance measuring device 30 and the associated method can also be used for moving walkways.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1-15. (canceled)

16. A method for measuring a braking distance of an escalator or moving walkway, wherein the escalator or moving walkway comprises a conveyor belt, at least one drive motor configured to drive the conveyor belt, a brake configured for braking the conveyor belt and a controller configured to control the drive motor and the brake, wherein a braking distance measuring device is removably arranged in a region of the conveyor belt, and wherein the braking distance measuring device comprises at least one trigger device connected to the controller, an optically detectable linear measuring scale, an optical sensor and an acoustic sensor, the method comprising:
arranging the linear measuring scale on the escalator or moving walkway in such a way that its course of movement relative to a marking as a result of a movement of the conveyor belt can be detected by the optical sensor;
brining the conveyor belt to a specified speed;
sending a stop signal to the controller with the trigger device once the specified speed is reached;
recording the relative course of movement using the optical sensor starting at least from receiving the stop signal until the conveyor belt comes to a complete standstill; and
recording the braking operation noises of the brake in synchronization with the recording of the relative course of movement using the acoustic sensor.

17. The method of claim 16, wherein the recording of the relative course of movement and the recording of the braking operation noises recorded synchronously with the relative movement are shown as a graphically displayed audio track, parallel to each other in an image sequence.

18. The method of claim 17, wherein a start position of the marking relative to the measuring scale is extracted from the image sequence using a start point of the braking operation noise, and an end position of the marking relative to the measuring scale is extracted from the elimination of the braking operation noise.

19. The method of claim 18, wherein the start position and end position are determined using an image processing program by carrying out an image analysis of the course of the recorded braking operation noises optically displayed in the image sequence and by marking in the image sequence the image of the image sequence containing the start point of the braking operation noise and one of the images of the image sequence in which the disappearance of the braking operation noise is recognized.

20. The method of claim 19, wherein the braking distance between the start position and the end position is determined by comparing the two marked images of the image sequence in that the different positions of the marking relative to the measuring scale are read out and the braking distance is determined by calculating the difference.

21. The method of claim 16, wherein the trigger device is connected to the controller and receives operating data of the drive motor from the controller, wherein a stop signal is sent to the controller when the drive motor has reached a speed that corresponds to the specified speed of the conveyor belt.

22. The method of claim 17, wherein the trigger device is connected to the controller and receives operating data of the drive motor from the controller, wherein a stop signal is sent to the controller when the drive motor has reached a speed that corresponds to the specified speed of the conveyor belt.

23. The method of claim 18, wherein the trigger device is connected to the controller and receives operating data of the drive motor from the controller, wherein a stop signal is sent to the controller when the drive motor has reached a speed that corresponds to the specified speed of the conveyor belt.

24. The method of claim 16, wherein a stop signal is manually input into the trigger device, which stop signal is transmitted directly from the trigger device to the controller.

25. The method of claim 17, wherein a stop signal is manually input into the trigger device, which stop signal is transmitted directly from the trigger device to the controller.

26. The method of claim 18, wherein a stop signal is manually input into the trigger device, which stop signal is transmitted directly from the trigger device to the controller.

27. A braking distance measuring device configured to carry out the method of claim 16 on an escalator or moving walkway, wherein the braking distance measuring device comprises at least one trigger device which is connected to the controller, an optically detectable linear measuring scale, an optical sensor, and an acoustic sensor.

28. The braking distance measuring device of claim 27, wherein the optical sensor, the acoustic sensor, and the trigger device are part of a smartphone or tablet comprising a software application, wherein the software application comprises at least program steps configured to record synchronously a movement of the marking relative to the measuring scale and of the braking operation noises.

29. The braking distance measuring device of claim 28, further comprising a holder for the smartphone or tablet, wherein the holder is removably arranged on a fixed part of an escalator or moving walkway.

30. An escalator or moving walkway comprising the brake measuring device of claim 27, wherein at least the linear measuring scale, the optical sensor, and the acoustic sensor of the braking distance measuring device are arranged in a drive region of the escalator or moving walkway.

31. An escalator or moving walkway comprising the brake measuring device of claim 28, wherein at least the linear measuring scale, the optical sensor, and the acoustic sensor of the braking distance measuring device are arranged in a drive region of the escalator or moving walkway.

32. The escalator or moving walkway of claim 30, wherein the marking is arranged or defined on the conveyor belt, and the measuring scale is arranged on a fixed part of the escalator or moving walkway.

33. The escalator or moving walkway of claim 32, wherein the marking is at least one of a gap between two escalator steps of the conveyor belt of the escalator, a gap between two pallets of the conveyor belt of the moving walkway, or a marking that can be temporarily applied to the conveyor belt.

34. The escalator or moving walkway of claim 30, wherein the measuring scale is arranged on the conveyor belt, and the marking is arranged on a fixed part of the escalator or moving walkway.

35. The escalator or moving walkway of claim 34, wherein the marking is an arrow-shaped sticker which is removably attached to a fixed part of the escalator or moving walkway.
